(19) United States
(12) Patent Application Publication
(10) Pub. No.: US 2017/0076363 A1
(43) Pub. Date: Mar. 16, 2017

(54) SYSTEMS AND METHODS FOR PROPERTY BIDDING AND FINANCING

(71) Applicant: KAHN VAN LE, RIVERSIDE, CA (US)

(72) Inventor: KAHN VAN LE, RIVERSIDE, CA (US)

(21) Appl. No.: 14/854,394

(22) Filed: Sep. 15, 2015

(51) Int. Cl. G06Q 30/08; G06Q 50/16

(52) U.S. Cl. CPC G06Q 30/08; G06Q 50/167

(57) ABSTRACT

A platform comprising systems, methods, and computer programs for online property bidding, commission bidding, loan ranking, referring, and agent rating is disclosed. The platform provides seller or buyer ways to optimize selling or buying property on their own or using agent services. Seller can post property for auction directly or post property via an agent. Buyer can bid directly on property or bid via an agent. Seller's agent or Buyer's agent bids to offer highest rebate based on commission or fee. The platform also provides a loan ranking system, an agent performance rating system and a referral process.

### CROSS REFERENCE TO RELATED APPLICATIONS

This application is a continuation-in-part of application Ser. No. 11/422,586, filed Jun. 6, 2006, now pending the entire specification of which is incorporated herein by reference, and claims priority benefit thereof.

### BACKGROUND OF THE INVENTION

1. Field of the Invention

The present invention provides systems and methods for buying, selling, and financing property and real estate.

2. Description of Related Art

In many markets worldwide, property prices have fluctuated noticeably and foreclosure is no longer a rare situation. Yet, traditional commission still represents a major cost to sell property. For agents or brokers, the trends are to provide discounts or rebates to property sellers or buyers in various forms. Agents or brokers are advertising monetary incentive for referrals or sales leads. Currently these discounts, rebates, referrals or sales leads are conducted in a sporadic and non-systematic way. Most importantly, current auction systems are lacking of innovative methods and features to make online property auction optimal and successful.

### BRIEF SUMMARY OF THE INVENTION

The present invention offers a new and innovative approach to solve these problems in property bidding and commission bidding. The invention provides seller or buyer ways to optimize selling or buying property via bidding on their own or using agent services. The invention provides ways to set, calculate, and present a predetermined number of winning bids. The invention also provides a loan ranking system so that borrower can optimally select loan offer, an agent rating process and a systematic referral process.

### BRIEF DESCRIPTION OF THE DRAWINGS

FIG. 1 shows a block diagram illustrating overview of the systems.

FIG. 2 shows relation between client and server.

FIG. 3A shows for direct bidding process.

FIG. 3B shows qualifying and bidding process related to FIG. 3A.

FIG. 3C shows user tools related to FIG. 3A.

FIG. 4A shows process of bidding via real estate agent.

FIG. 4B shows qualifying and bidding process related to FIG. 4A.

FIG. 4C shows user tools related to FIG. 4A

FIG. 4D shows relation between property description page and agent page.

FIG. 5A shows process of seller's agent commission bidding.

FIG. 5B shows qualifying and bidding process related to FIG. 5A.

FIG. 5C shows user tools related to FIG. 5A.

FIG. 6A shows process of buyer's agent commission bidding.

FIG. 6B shows qualifying and bidding process related to FIG. 6A

FIG. 6C shows user tools related to FIG. 6A.

FIG. 7A shows loan ranking process.

FIG. 7B shows form for loan posting.

FIG. 7C shows form for selecting loan offers.

FIG. 7D shows display of loan offers ranking.

FIG. 8A shows agent performance rating process

FIG. 8B shows display of agent performance rating.

FIG. 9 shows referral process.

### DETAILED DESCRIPTION OF THE INVENTION

The present invention provides systems and methods for online posting, searching, communicating, buying or selling property via bidding, referring, agent rating, and loan or mortgage ranking. The present invention can be used for auctioning property, real estate (RE) or for bidding to provide service. While the invention will be described using these embodiments, it is understood that the invention is not limited by these representations. The invention is intended to cover alternatives and modifications within the scope of the invention as defined in the enclosed claims.

Users include property seller, property buyer, agent, including real estate agent or broker, loan agent or broker, and referrer. Approved bidders or qualified bidders who satisfy bidding criteria are permitted to bid. Bidding criteria include creditworthy and financial conditions, locality, years of experience, second language ability, preferred agent (agent who are preferred and specified by seller or buyer). User communicates with each other by sending message via web site, email, personal digital device (PDA), mobile device or phone. Communicating messages include sales leads, referrals, information or quotes, loan or financial matters etc., concerning property, seller, buyer, borrower, agent or broker.

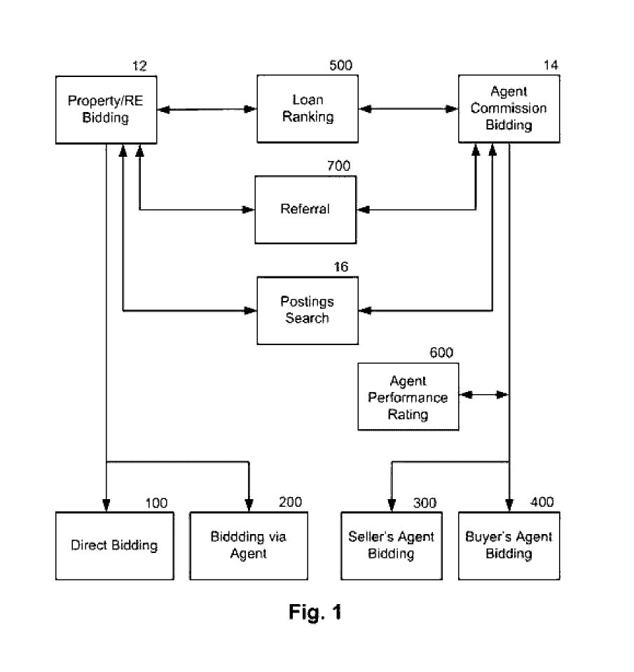

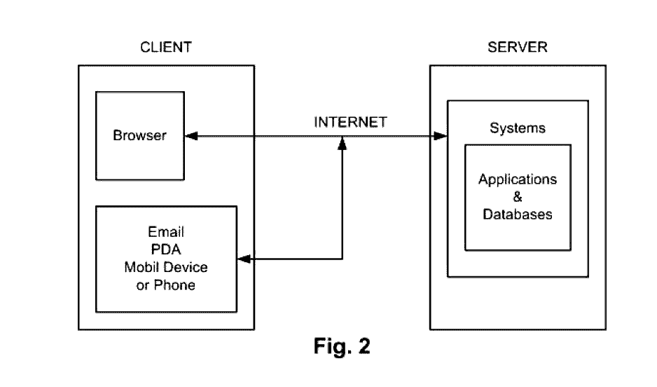

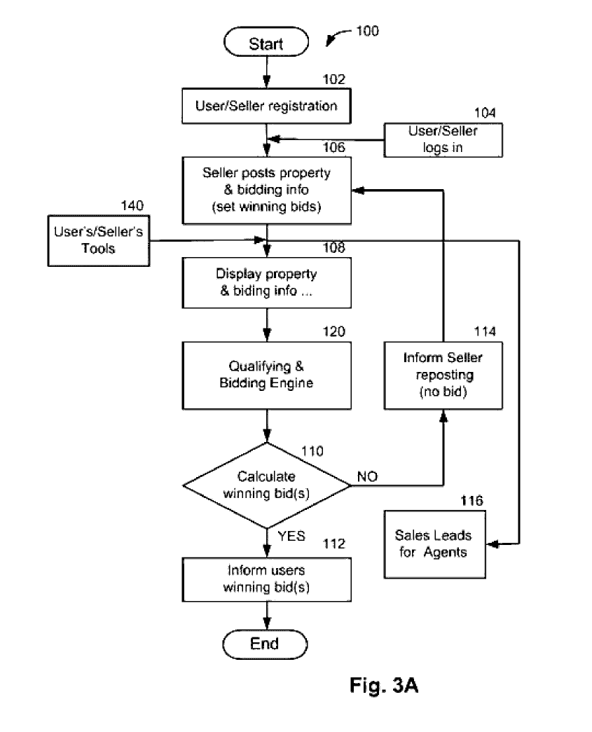

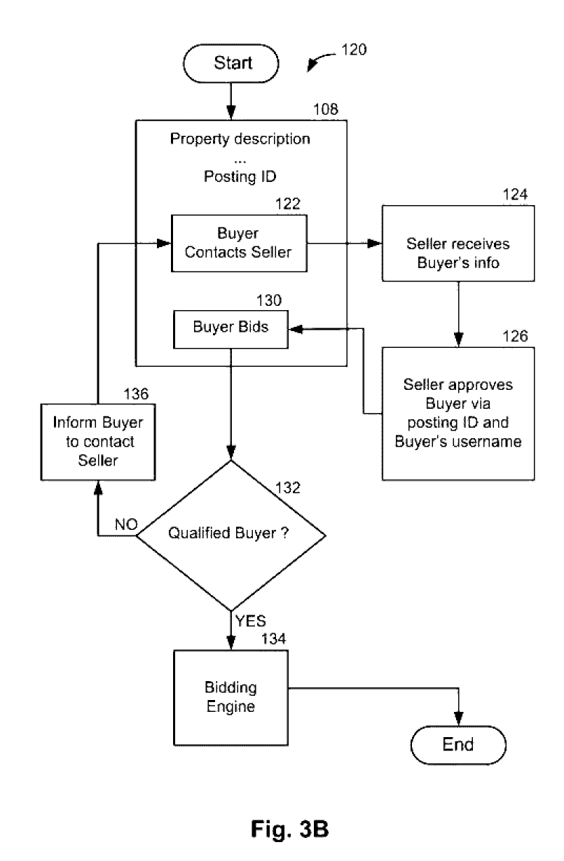

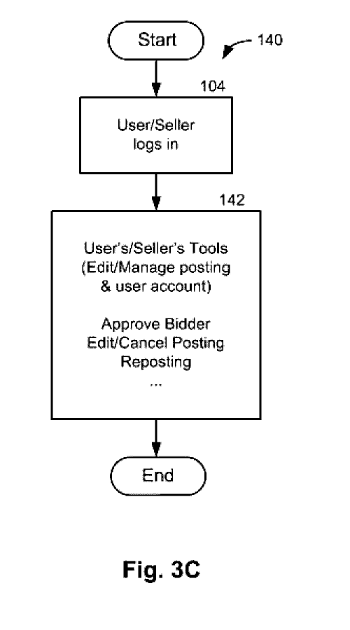

FIG. 1, in an embodiment of the invention, shows a block diagram of Property Bidding system 12, Agent Commission Bidding system 14, and Postings Search system 16, Loan Ranking system 500, Agent Performance Rating system 600 and Referral system 700. System 12 consists of Direct Bidding system 100 and Bidding via Agent system 200. System 14 consists of Seller's Agent Bidding system 300 and Buyer's Agent Bidding system 400. System 100 can be used as a For-Sale-By-Owner (FSBO) system. In system 16, user can search postings by keywords or posting ID (identification). FIG. 2 illustrates the relation between Client and Server computer systems. The processes described in FIGS. 3A, 3B, 4A, 4B, 5A, 5B, 6A and 6B provide means for posting information, bidding, and communicating of users; means for permitting qualified bidders to bid; and means for setting and calculating a predetermined number of winning bids.

FIG. 3A, in an embodiment of the invention, shows a flowchart of system 100. Seller can register at step 102 and post property for auction directly at step 106 so buyer can bid on property directly. In step 106, seller can set the predetermined number of winning bids. The predetermined number can be set to 1 or greater (more than one winning bid). Step 108 displays property and bidding information. Step 120 shows qualifying and bidding process. Step 110 checks if any bid exists and calculates bidding result. If there is no bid, step 114 informs seller of no bid and asks seller to repost or make change. If bidding exists, step 112 informs winners and seller about winning bidders. In step 110, the system calculates a predetermined number of winning bids. The system provides seller a choice to select the best buyer among winning bidders, from the seller point of view. For example, when the predetermined number of winning bids is set to 2, seller can select one between two potential buyers: a buyer who offers to pay a higher property price via financing or a buyer who offers to pay a little less with all cash. Note that seller has buyer's information during qualifying process. Step 116 provides sales leads for property/real estate agents. After a seller completes his or her posting, a mechanism is run to send out sales leads to agents via email, PDA (personal digital device), mobile device or phone.

FIG. 3B, in an embodiment of the invention, shows a flowchart of section 120 illustrating buyer qualifying and bidding process. Prospective buyer must get approval from seller before bidding. From step 108, display of property and bidding information, buyer uses step 122 to initiate a form to contact seller. Seller receives buyer's information at step 124. At step 126, seller approves buyer for bidding based on buyer's creditworthy and financial conditions, via posting ID and Buyer's username. When buyer initiates bidding step 130 and enters and submits a bid value, the system will check for buyer qualification. If buyer is qualified (approved for bidding), the process continues and Bidding Engine 134 will perform auction functions (i.e., record current highest bid, bidder's username, informing other bidder being outbid, etc.). If buyer is not qualified, the system prompts buyer at step 136 to contact seller to get approval for bidding.

The system can enable or disable an Auto Bidding feature, wherein a bidder set a maximum bid and bidding is increased automatically per bid increment until the maximum amount is reached each time said bidder is outbid by others.

FIG. 3C, in an embodiment of the invention, shows a flowchart of section 140 illustrating seller's tools 142 for editing or managing posting and user account, after login at step 104. These tools include Edit/Cancel Posting, Reposting, Approve Bidder, Upload/Delete Property Images, Get Referral Code, Update Personal Information, Forget/Change Password, etc. The Edit/Cancel Posting tool allows seller to edit seller's posting, including setting predetermined number of winning bids, during auction preview period. Once auction starts, seller cannot edit or cancel posting. The Approve Bidder tool allows seller to approve bidders until auction period is ended.

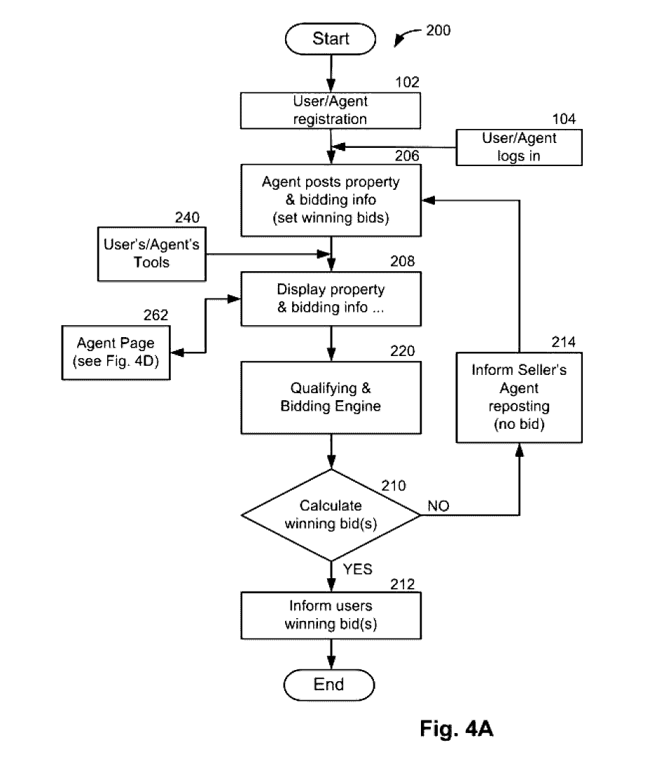

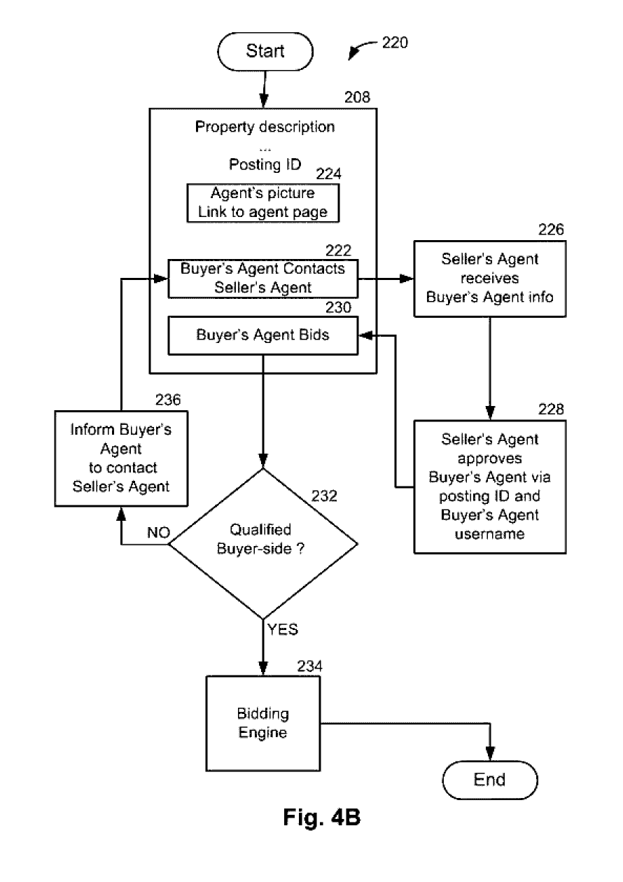

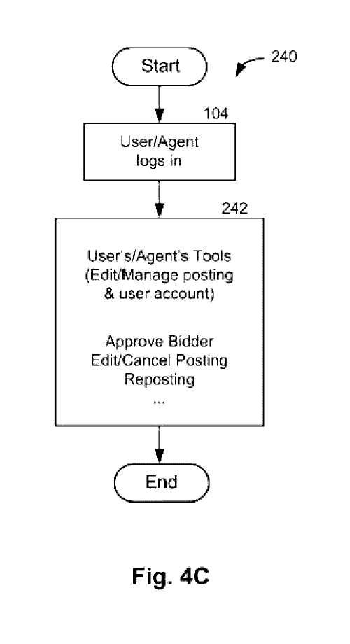

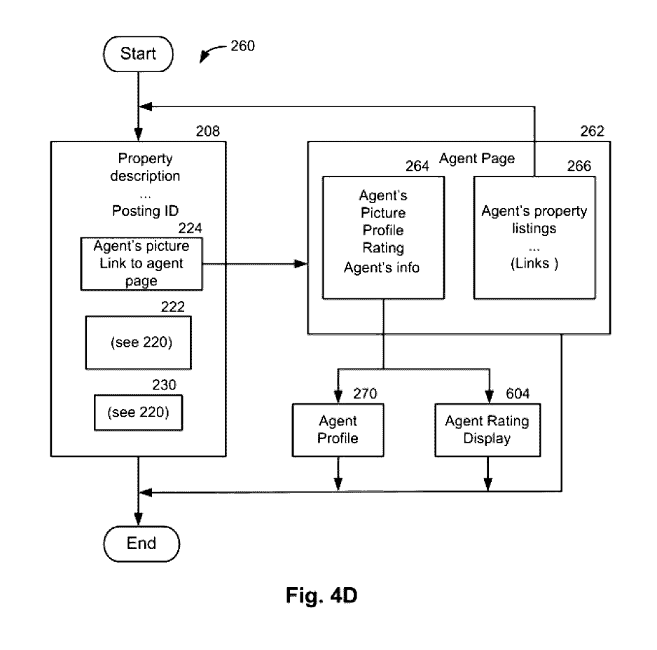

FIG. 4A, in an embodiment of the invention, shows a flowchart of system 200. System 200 can be used by property owner, lender or bank (including REO foreclosure) or new home builder. Seller (owner), via agent, can register at step 102 and post property for auction at step 206 so that buyer, via real estate agent, can bid on property. In step 206, seller's agent can set the predetermined number of winning bids. The predetermined number can be set to 1 or greater (more than one winning bid). Each side is represented by an agent who interacts directly with the system. Step 208 displays property and bidding information. Section 220 shows qualifying and bidding process. Step 210 checks if any bid exists and calculates bidding result. If there is no bid, step 214 informs seller side of no bid and asks seller side to repost or make change. If bidding exists, step 212 informs winners and seller side about winning bidders. In step 210, the system calculates a predetermined number of winning bids. The system provides seller side a choice to select the best buyer among winning bidders, from the seller side point of view. For example, when the predetermined number of winning bids is set to 2, seller side can select one between two potential buyers: a buyer who offers to pay a higher property price via financing or a buyer who offers to pay a little less with all cash. Note that seller side has buyer-side's information during qualifying process.

FIG. 4B, in an embodiment of the invention, shows a flowchart of section 220 illustrating buyer-side's qualifying and bidding process. Buyer side (prospective buyer and buyer's agent) must get approval from seller-side (seller and seller's agent) before bidding. From step 208, display of property and bidding information, buyer's agent uses step 222 to initiate a form to contact seller's agent. Seller's agent receives buyer side's information at step 226. At step 228, seller's agent approves buyer side for bidding based on buyer's creditworthy and financial conditions, via posting ID and Buyer's agent username. When buyer's agent initiates bidding step 230 and enters and submits a bid value, the system will check for buyer side qualification at step 232. If buyer side is qualified (approved for bidding), the process continues and Bidding Engine 234 will perform auction functions (i.e., record current highest bid, bidder's username, informing other bidder being outbid, etc.). If buyer side is not qualified, the system prompts buyer side at step 236 to contact seller's agent to get approval for bidding.

The system can enable or disable an Auto Bidding feature, wherein a bidder set a maximum bid and bidding is increased automatically per bid increment until the maximum amount is reached each time said bidder is outbid by others.

FIG. 4C, in an embodiment of the invention, shows a flowchart of section 240 illustrating seller-agent's tools 242 for editing or managing posting and user account, after login at step 104. These tools include Edit/Cancel Posting, Reposting, Approve Bidder, Upload/Delete Property Images, Get Referral Code, Update Personal Information, Update Agent's Profile, Upload Agent's Picture, Forget/Change Password, etc. The Edit/Cancel Posting tool allows seller's agent to edit seller-agent's posting, including setting predetermined number of winning bids, during auction preview period. Once auction starts, seller's agent cannot edit or cancel posting. The Approve Bidder tool allows seller's agent to approve bidders until auction period is ended.

FIG. 4D, in an embodiment of the invention, shows a flowchart of section 260 illustrating seller-agent's posting information 208 relates with the Agent Page 262. Section 262 includes agent's background information 264 and agent's property listings 266. Section 264 includes Agent Profile 270 and Agent Rating 604.

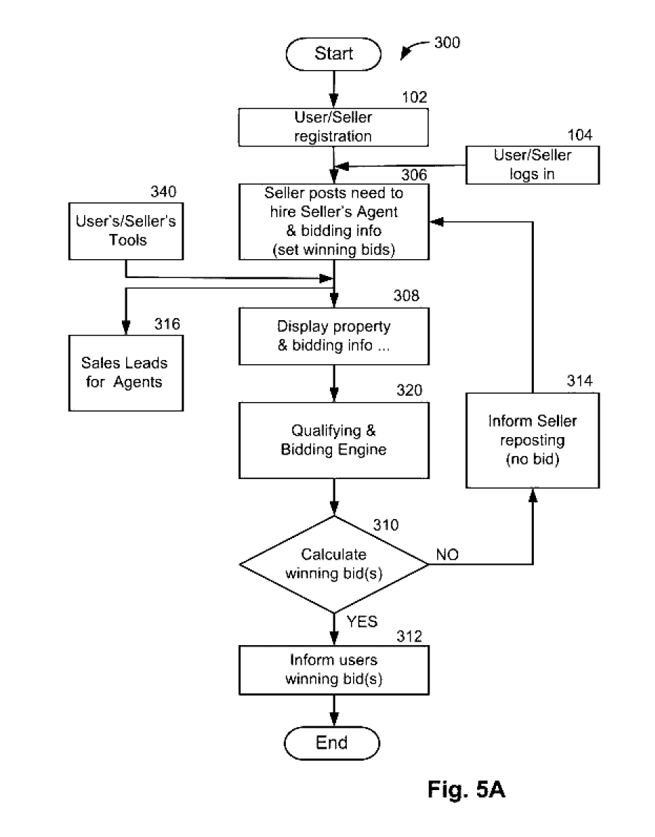

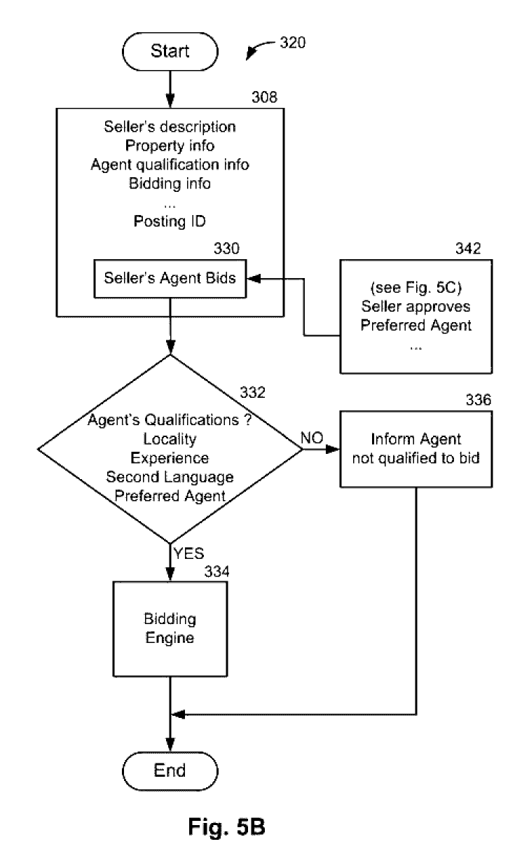

FIG. 5A, in an embodiment of the invention, shows a flowchart of Agent Commission Bidding system 300. Seller can register at step 102 and post need to hire agent at step 306 and prospective agents can bid to become seller's agent (listing agent). In step 306, seller can set the predetermined number of winning bids. The predetermined number can be set to 1 or greater (more than one winning bid). Step 308 displays property and bidding information. Section 320 shows qualifying and bidding process. Step 310 checks if any bid exists and calculates bidding result. If there is no bid, step 314 informs seller of no bid and asks seller to repost or make change. If bidding exists, step 312 informs winners and seller about winning bidders. In step 310, the system calculates a predetermined number of winning bids. The system provides seller a choice to select the best agent among winning bidders, from the seller point of view. For example, when the predetermined number of winning bids is set to 3, seller can select one among 3 prospective agents, after interviewing agents. In case of Preferred Agents bidding, the predetermined number of winning bid can be set to 1.Step 316 provides sales leads for property/real estate agents. After a seller completes his or her posting, a mechanism is run to send out sales leads to agents via email, PDA (personal digital device), mobile device or phone.

FIG. 5B, in an embodiment of the invention, shows a flowchart of section 320 illustrating prospective seller's agent (listing agent) qualifying and bidding process. Prospective seller's agent must get approval from seller before bidding. Step 308 displays property and bidding information. When prospective seller's agent initiates bidding step 330 and enters and submits a bid value, the system will check for prospective agent's qualifications. Agent's qualifications may include any combination of agent's locality, agent's years of experience, and agent's second language ability. Note that agent's qualifications are set in posting form 306 (FIG. 5A). Step 332 checks agent's qualifications. If seller wants only bidding among agents that seller prefers (seller already has knowledge about agent's reputation, agent's ability, past representation or known selling record, etc.), seller can approve Preferred Agents for bidding. This is a special category of agent's qualification, which must be set by seller via step 342. Once the Preferred Agent qualification is set; it will override all other qualifications. If agent is qualified (approved for bidding), the process continues and Bidding Engine 334 will perform auction functions (i.e., record current highest bid, bidder's username, informing other bidder being outbid etc.). Step 336 informs agent if agent is not qualified and therefore cannot bid.

In system 300, seller's agents bid to offer rebate based on a known total commission or fee, which can be set by the seller. In effect, seller's agents bid to offer lowest total commission or fee. For example, a known total commission set at 6%, for a property worth $500,000, if the final winning rebate is 2%, then resultant total commission is 4% or $20,000. The resultant total commission may include the buyer-agent's share (commission/fee). Seller, when posting property, sets the initial or minimum-winning bid and bid increment.

The system can enable or disable an Auto Bidding feature, wherein a bidder set a maximum bid and bidding is increased automatically per bid increment until the maximum amount is reached each time said bidder is outbid by others.

FIG. 5C, in an embodiment of the invention, shows a flowchart of section 340 illustrating seller's tools 342 for editing or managing posting and user account, after login at step 104. These tools include Edit/Cancel Posting, Repost Need To Hire Agent, Approve Preferred Agent, Upload/Delete Property Images, Get Referral Code, Update Personal Information, Forget/Change Password, etc. The Edit/Cancel Posting tool allows seller to edit seller's posting, including setting predetermined number of winning bids, during auction preview period. Once auction starts, seller cannot edit or cancel posting. The Approve Bidder tool allows seller to approve bidders until auction period is ended.

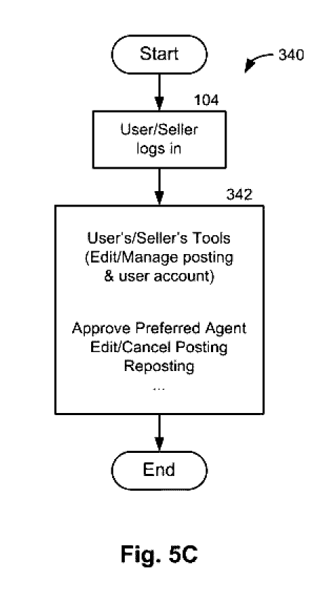

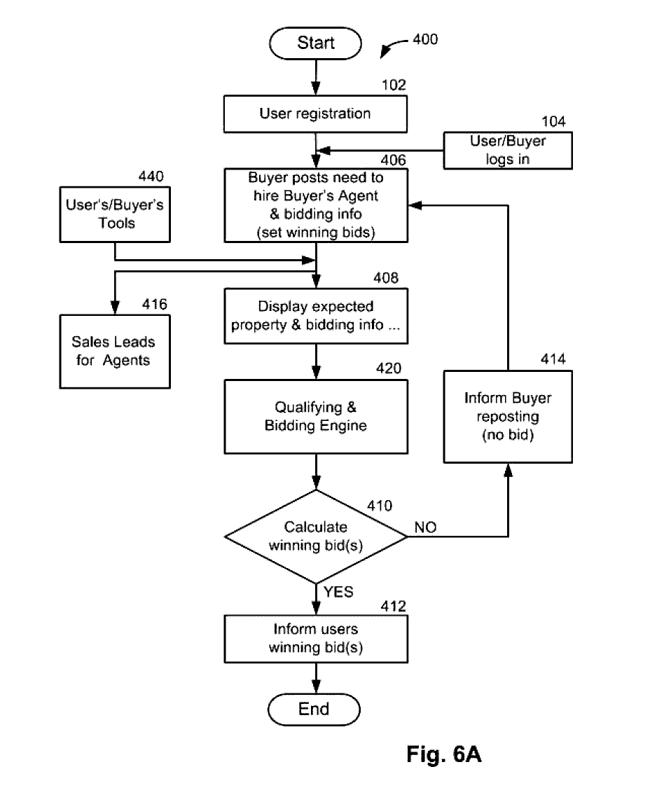

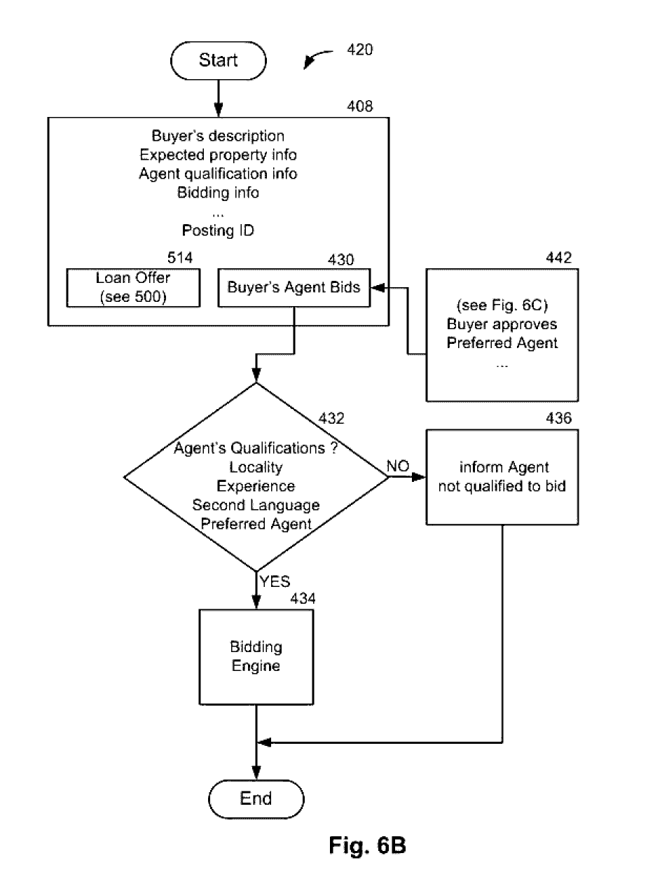

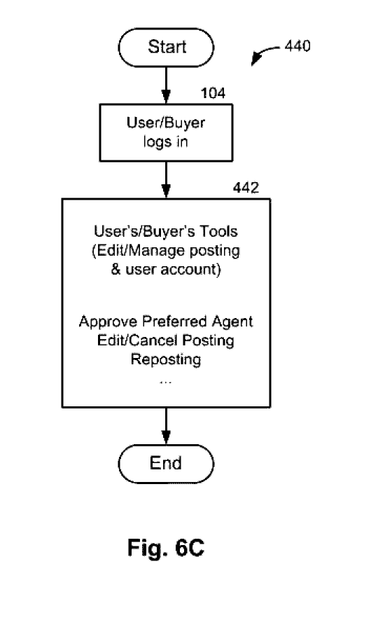

FIG. 6A, in an embodiment of the invention, shows a flowchart of Agent Commission Bidding system 400. Buyer can register at step 102 and post need to hire agent at step 406 and prospective agents can bid to become buyer's agent. In step 406, buyer can set the predetermined number of winning bids. The predetermined number can be set to 1 or greater (more than one winning bid). Step 408 displays expected property and bidding information. Section 420 shows qualifying and bidding process. Step 410 checks if any bid exists and calculates bidding result. If there is no bid, step 414 informs buyer of no bid and asks buyer to repost or make change. If bidding exists, step 412 informs winners and buyer about winning bidders. In step 410, the system calculates a predetermined number of winning bids. The system provides buyer a choice to select the best agent among winning bidders, from the buyer point of view. For example, when the predetermined number of winning bids is set to 3, buyer can select one among 3 prospective agents, after interviewing agents. In case of Preferred Agents bidding, the predetermined number of winning bid can be set to 1.Step 416 provides sales leads for property/real estate and loan agents. After a buyer completes his or her posting, a mechanism is run to send out sales leads to agents via email, PDA (personal digital device), mobile device or phone.

FIG. 6B, in an embodiment of the invention, shows a flowchart of section 420 illustrating prospective buyer's agent qualifying and bidding process. Prospective buyer's agent must get approval from buyer before bidding. Step 408 displays expected property and bidding information. When prospective buyer's agent initiates bidding step 430 and enters and submits a bid value, the system will check for prospective agent's qualifications. Agent's qualifications may include any combination of agent's locality, agent's years of experience, and agent's second language ability. Note that agent's qualifications are set in posting form 406. Step 432 checks agent's qualifications. If buyer wants only bidding among agents that buyer prefers (buyer already has knowledge about agent's reputation, agent's ability, past representation or known selling record, etc.), buyer can approve Preferred Agents for bidding. This is a special category of agent's qualification, which must be set by buyer via step 442. Once the Preferred Agent qualification is set; it will override all other qualifications. If agent is qualified (approved for bidding), the process continues and Bidding Engine 434 will perform auction functions (i.e., record current highest bid, bidder's username, informing other bidder being outbid, etc.). Step 436 informs agent if agent is not qualified and therefore cannot bid. Loan agent can use Loan Offer step 514 to initiate step 516 in which agent can make loan offer to buyer via email, PDA, mobile device or phone.

In system 400, buyer's agents bid to offer rebate based on buyer-agent's commission or fee. In effect, buyer's agents bid to offer lowest commission or fee. For example, for a property worth $500,000 and the buyer-agent's share is 3% ($15,000), if the final winning rebate is 40% (of agent's fee), then the rebate given to buyer is $6,000, and the resulting fee of the buying agent is $9,000. Buyer, when posting request for agent services, sets the initial or minimum-winning bid and bid increment.

The system can enable or disable an Auto Bidding feature, wherein a bidder set a maximum bid and bidding is increased automatically per bid increment until the maximum amount is reached each time said bidder is outbid by others.

FIG. 6C, in an embodiment of the invention, shows a flowchart of section 440 illustrating buyer's tools 442 for editing or managing posting and user account, after login at step 104. These tools include Edit/Cancel Posting, Repost Need To Hire Agent, Approve Preferred Agent, Upload/Delete Property Images, Get Referral Code, Update Personal Information, Forget/Change Password, etc. The Edit/Cancel Posting tool allows buyer to edit buyer's posting, including setting predetermined number of winning bids, during auction preview period. Once auction starts, buyer cannot edit or cancel posting. The Approve Bidder tool allows buyer to approve bidders until auction period is ended.

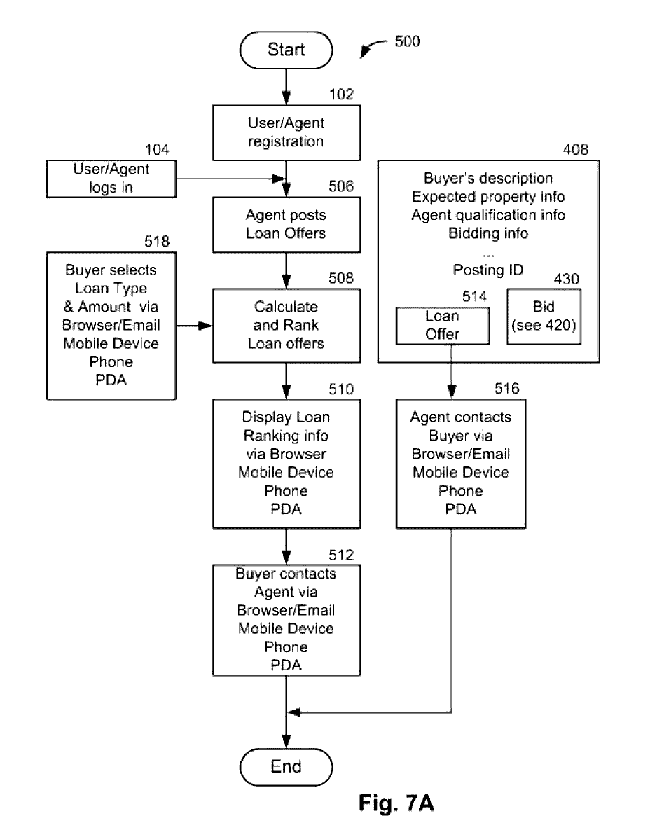

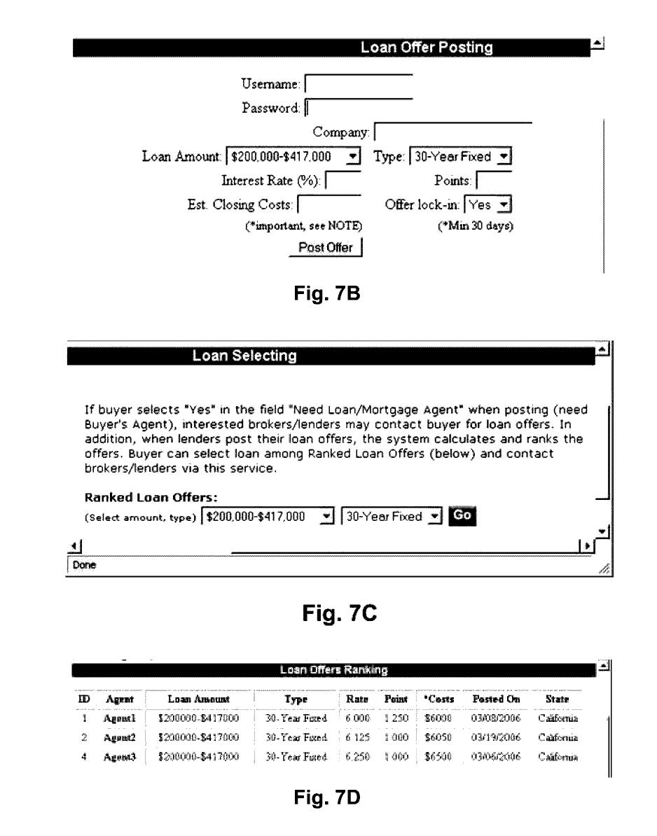

FIG. 7A, in an embodiment of the invention, shows a flowchart of Loan Ranking system 500. The system ranks loan or mortgage offers from loan or mortgage agents or companies. Loan agent can register at step 102 and post loan offer at step 506. Buyer or borrower can select loan type and loan amount at step 518. The system calculates and ranks loan offers at step 508 and displays loan ranking at step 510. Step 510 has hyperlinks or buttons for buyer or borrower to contact loan agents or companies. Buyer or borrower can contact agent via email, mobile device, phone or PDA at step 512. Loan agent can use Loan Offer step 514 to initiate step 516. In step 516, loan agent can make loan offer to buyer or borrower via email, PDA, mobile device or phone. The calculation and ranking are based on loan interest rate, lender fee or point, and closing cost. The system also evaluates loan amount and loan type (fixed-rate or adjustable rate). In one embodiment, for example, a fixed-rate loan in the range of $200,000-$417,000, annual interest rate=6.0%, points (or lender fee)=1.25 and estimate closing cost=$6,000. Using “point” as equalizing unit (1 unit=1 “point” or one percentage point), the system determines or sets an X coefficient for calculating the representing value of closing cost. X depends on loan range. The system determines or sets a Y coefficient for calculating the representing value of points (or lender fee) and the system determines or sets a Z coefficient for calculating the representing value of interest rate. Z depends on loan type (fixed rate or adjustable rate). The system then calculates the overall representing value of each loan and ranks loan offers.

FIG. 7B, in an embodiment of the invention, shows a form for loan agent or company to post loan offer at step 506.

FIG. 7C, in an embodiment of the invention, shows a form for buyer or borrower to select loan type and loan amount at step 518.

FIG. 7D, in an embodiment of the invention, shows loan offers ranking, in the order of optimal loans, at step 510.

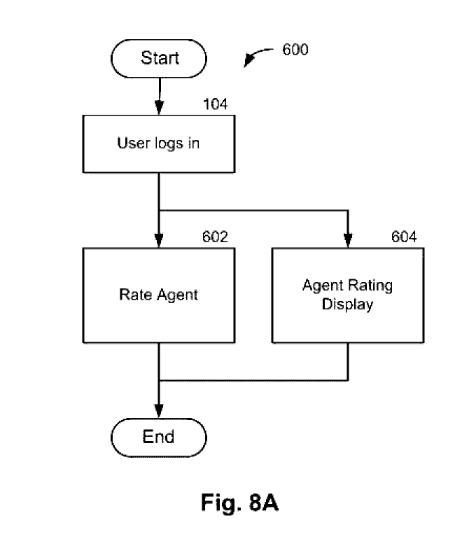

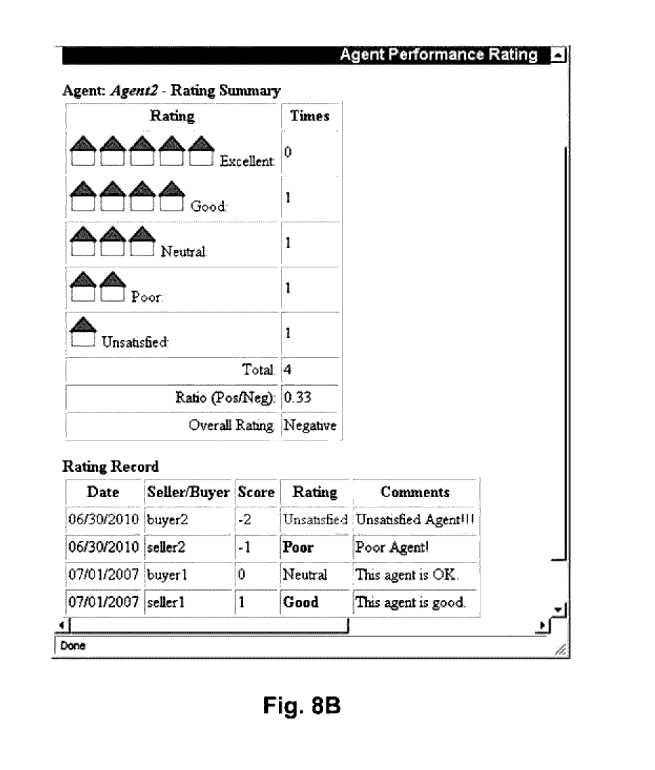

FIG. 8A, in an embodiment of the invention, shows a flowchart of Agent Performance Rating system 600. Seller or buyer logs in at step 104. Seller or buyer can view Agent Rating at step 604. Seller or buyer can rate an agent at step 602.

FIG. 8B, in an embodiment of the invention, shows a display of Agent Performance Rating.

FIGS. 8A and 8B, in an embodiment of the invention, system 600 provides users (sellers or buyers) with 5 grades: Excellent, Good, Neutral, Poor and Unsatisfied with Unsatisfied as lowest grade. An Excellent grade equals score of 2, a Good grade equals 1, a Neutral grade equals 0, a Poor grade equals—1, and an Unsatisfied grade equals—2. The overall rating is derived from the absolute value of the ratio of the total positive scores over the total negative scores. If the ratio is less than 1, the overall rating is negative. If the ratio is greater than 1, the overall rating is positive. If the ratio equals 1, overall rating is neutral. In case there are positive scores and no negative scores, the overall rating is positive. In case there are negative scores and no positive scores, the overall rating is negative. The system records and displays a Rating Summary and a Rating Record. Rating Summary shows given grade, number of times each grade is given, the total number of ratings provided by users, the ratio, and the overall rating. Each grade may be shown along with a house symbol made of a isosceles triangle on top of a rectangle laid on the longer horizontal side; the lowest rating and the highest rating are represented by 1 symbol 5 symbols respectively. Rating Record shows date, username, score, rating, and comments.

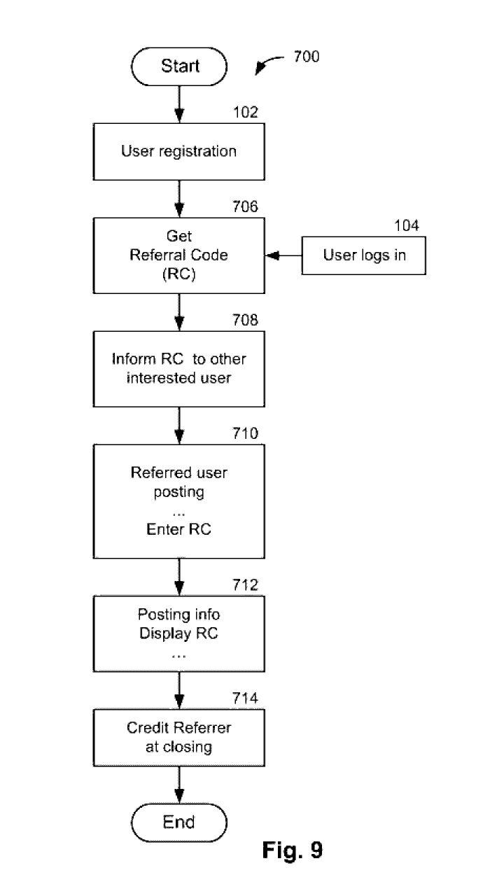

FIG. 9, in an embodiment of the invention, shows a flowchart of referral system 700. The system provides user a unique referral code. The referral code can be obtained at step 706 after user completes registration at step 102 or user can log in at step 104 at a later time and obtain the code. Referrer informs referral code to other interested user at step 708. Interested user enters referral code when posting at step 710. Step 710 is the referral code entering part of steps 106, 206, 306 and 406, in relation to each system. Step 712 is the referral code displaying part of steps 108, 208, 308 and 408, in relation to each system. The system displays referral code, when applicable, as part of user's posting at step 712. In step 714, the system calculates referral value, which may depend on closing property value, and credits referrer at closing of property/real estate transactions.

What is claimed is:

1: A method in a computer system for bidding online or on the Internet comprising:
(a) means for posting information, bidding, and communicating of users;
(b) means for permitting qualified bidders to bid;
(c) means for setting and calculating a predetermined number of winning bids;
wherein said bidding comprising property bidding or commission bidding.

2: The method of claim 1 wherein said users comprising seller, buyer, referrer, and agent comprising real estate, loan agent or broker.

3: The method of claim 1 wherein the bidding means in said commission biding comprising agents bid to offer highest rebate or lowest commission or fee.

4: The method of claim 1 wherein the posting means comprising posting property for auction directly by seller and wherein the bidding means comprising bidding directly by buyer.

5: The method of claim 1 wherein the posting means comprising posting property for auction via an agent and wherein the bidding means comprising bidding via an agent.

6: The method of claim 1 wherein the permitting means is based at least on creditworthy and financial conditions of buyers.

7: The method of claim 1 wherein the permitting means in said commission biding is based at least on agent's years of experience.

8: The method of claim 1 wherein the permitting means in said commission biding is based at least on agent's locality.

9: The method of claim 1 wherein the permitting means in said commission biding is based at least on agent's second language ability.

10: The method of claim 1 wherein the permitting means in said commission bidding is based at least on preferred agents.

11: The method of claim 1 wherein the communicating means comprising providing sales leads to agents.

12: The method of claim 1 wherein the communicating means in said commission biding comprising providing sales leads based at least on agent's locality.

13: The method of claim 1 wherein the communicating means in said commission biding comprising providing sales leads based at least on agent's years of experience.

14: The method of claim 1 wherein the communicating means in said commission biding comprising providing sales leads based at least on agent's second language ability.

15: The method of claim 1 wherein the communicating means comprising web site, email, personal digital device, mobile device or phone.

16: The method of claim 1 wherein the communicating means comprising means for making referrals.

17: A method in a computer system for loan ranking online or on the Internet comprising:
(a) means for posting information and communicating of borrower, loan agent or broker;
(b) means for calculating and ranking information based on elements comprising interest rates, lender fees or points, and closing costs;
(c) presenting information in the order of optimal loans.

18: The method of claim 17 wherein the calculating means further comprising loan type and loan amount.

19: The method of claim 17 wherein the communicating means comprising web site, email, personal digital device, mobile device or phone.
